(19) United States
(12) Patent Application Publication
(10) Pub. No.: US 2026/0278690 A1
(43) Pub. Date: Sep. 17, 2026

(54) SYSTEM AND METHOD FOR DATA-DRIVEN PREDICTION

(71) Applicant: State Farm Mutual Automobile Insurance Company, Bloomington, IL (US)

(72) Inventor: Christopher N. Otterman, Bloomington, IL (US)

(73) Assignee: State Farm Mutual Automobile Insurance Company, Bloomington, IL (US)

(21) Appl. No.: 19/086,479

(22) Filed: Mar. 21, 2025

Related U.S. Application Data
(60) Provisional application No. 63/771,413, filed on Mar. 13, 2025.

(51) Int. Cl. G06Q 40/08; G06F 17/18; G06Q 10/04

(52) U.S. Cl. CPC G06Q 40/08; G06F 17/18; G06Q 10/04

(57) ABSTRACT

System and methods for predicting pure rate for coverage program(s) are disclosed. The method may include, such as by one or more processors, transceivers, and/or sensors: (1) collecting rate data associated with coverage program(s) during a first time threshold; (2) transforming the rate data by applying a natural logarithm function; (3) determining data pattern(s) corresponding to the transformed rate data; (4) utilizing a regression function to calculate an intercept and a slope that correspond to a trend line of the data pattern(s) over a second time threshold; (5) predicting projected rate value(s) for a future point in time using an exponential equation; (6) generating a plot based upon the intercept, slope, and projected rate value(s); (7) analyzing the plot to determine a range of projected rate values for future point in time; and/or (8) outputting the range of projected rate values for future point in time based upon the plot.

### CROSS-REFERENCE TO RELATED APPLICATION

This patent application claims the benefit of priority to U.S. Provisional Application No. 63/771,413, filed on Mar. 13, 2025, the entirety of which is incorporated herein by reference.

### TECHNICAL FIELD

This present disclosure relates generally to the field of data processing and predictive analysis. In particular, the present disclosure relates to systems and methods for forecasting pure premiums using an algorithmic approach, as well as leveraging exponential trend analysis and machine-learning models to optimize rate-setting accuracy and accelerate responsiveness to changing market conditions.

### BACKGROUND

Traditional systems and methods for forecasting pure premiums may rely heavily upon manual analyses of frequency and severity trends, followed by a discussion with others to determine rate indications. This approach may be time-consuming and may significantly slow down time-to-market agility, leading to delayed rate filings and slower responses to changing market dynamics. Additionally, conventional forecasting techniques may typically forecast over longer time horizons, which may increase prediction volatility and introduce greater uncertainty. These techniques may predominantly depend upon historical data, resulting in limiting adaptability to emerging trends and market fluctuations.

The traditional approaches may lack the capability to seamlessly integrate continuous data inputs or perform real-time adjustments, resulting in static projections that may not accurately reflect the evolving risk landscape. Furthermore, the absence of algorithmic modeling and advanced statistical techniques may restrict precision and scalability, thereby complicating the optimization of profitability, competitiveness, and regulatory compliance. Moreover, the traditional methods may be technically challenged regarding integrating machine-learning models due to their rigid, rule-based framework. Such a drawback may hinder the ability to detect complex patterns and non-linear relationships within the data, resulting in limiting the accuracy and responsiveness to pure premium predictions. Conventional techniques may include other ineffectiveness, encumbrances, inefficiencies, and drawbacks, as well.

### SUMMARY

The present embodiments may relate, inter alia, to data-driven forecasting for premium rate estimation and adjustment, such as those discussed above and elsewhere herein. Specifically, the present computer systems and computer-implemented methods may solve technical challenges by leveraging logarithmic transformations, linear regression, exponential forecasting, and/or machine-learning models to enhance the accuracy and responsiveness of premium projections. By automating data transformation, trend detection, and/or forecast generation, the systems and methods may enable efficient and precise rate adjustments. Additionally, the incorporation of percentile-based adjustments, dynamic weighting, and/or visualization techniques may ensure that forecasts remain stable while adapting to recent market trends.

In one aspect, a computer-implemented method for predicting a pure rate for one or more coverage programs may be provided. The computer-implemented method may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another and operate as input and/or output devices. In one instance, the computer-implemented method may be performed by one or more local or remote processors of a computing system in communication with one or more local or remote data sources.

The computer-implemented method may include, via one or more local or remote processors, transceivers, sensors, servers, and/or other components: (1) collecting, by the one or more processors, rate data associated with the one or more coverage programs during a first time threshold; (2) transforming, by the one or more processors, the rate data by applying a natural logarithm function to the rate data; (3) determining, by the one or more processors, one or more data patterns corresponding to the transformed rate data; (4) utilizing, by the one or more processors, a regression function to calculate an intercept and a slope that correspond to a trend line of the one or more data patterns over a second time threshold; (5) predicting, by the one or more processors, one or more projected rate values for a future point in time using an exponential equation; (6) generating, by the one or more processors, a plot based upon the intercept, the slope, and the one or more projected rate values; (7) analyzing, by the one or more processors, the plot to determine a range of projected rate values for the future point in time; and/or (8) outputting, by the one or more processors, the range of projected rate values for the future point in time based upon the plot. The output may be visual, graphical, textual, text-based, audible, and/or verbal. For instance, the output may be displayed on a computer screen or mobile device (or otherwise displayed visually for the user), and/or the output may be presented audibly to the user (such as via a voice bot or chatbot, such as ChatGPT or generative AI-based bot). The method may include additional, less, or alternate functionality, including that discussed elsewhere herein.

In another aspect, a computer system for predicting a pure rate for one or more coverage programs may be provided. The computer system may be implemented via one or more local or remote processors, servers, transceivers, memory units, mobile devices, voice bots or chatbots, ChatGPT bots, InstructGPT bots, Codex bots, Google Bard bots, generative AI-based bots, and/or other electronic or electrical components, which may be in wired or wireless communication with one another. In one instance, the computer system may be performed by one or more local or remote processors of a computing system in communication with one or more local or remote data sources, and at least one non-transitory computer readable medium storing instructions which, when executed by the one or more processors, cause the one or more processors to perform certain operations.

The computer system may include, via one or more processors, non-transitory computer readable medium, transceivers, sensors, servers, and/or other components to perform operations that may include: (1) collecting rate data associated with the one or more coverage programs during a first time threshold; (2) transforming the rate data by applying a natural logarithm function to the rate data; (3) determining one or more data patterns corresponding to the transformed rate data; (4) utilizing a regression function to calculate an intercept and a slope that correspond to a trend line of the one or more data patterns over a second time threshold; (5) predicting one or more projected rate values for a future point in time using an exponential equation; (6) generating a plot based upon the intercept, the slope, and the one or more projected rate values; (7) analyzing the plot to determine a range of projected rate values for the future point in time; and/or (8) outputting the range of projected rate values for the future point in time based upon the plot. The system may include additional, less, or alternate functionality, including that discussed elsewhere herein.

In yet another aspect, a non-transitory computer readable medium for predicting a pure rate for one or more coverage programs may be provided. The non-transitory computer readable medium may be implemented via one or more local or remote processors, servers, transceivers, memory units, mobile devices, voice bots or chatbots, ChatGPT bots, InstructGPT bots, Codex bots, Google Bard bots, and/or other electronic or electrical components, which may be in wired or wireless communication with one another. In one instance, the non-transitory computer readable medium may be performed by one or more local or remote processors of a computing system in communication with one or more local or remote data sources, and at least one non-transitory computer readable medium storing instructions which, when executed by the one or more processors, cause the one or more processors to perform certain operations.

The non-transitory computer readable medium may include, via one or more processors, transceivers, sensors, servers, and/or other components: (1) collecting rate data associated with the one or more coverage programs during a first time threshold; (2) transforming the rate data by applying a natural logarithm function to the rate data; (3) determining one or more data patterns corresponding to the transformed rate data; (4) utilizing a regression function to calculate an intercept and a slope that correspond to a trend line of the one or more data patterns over a second time threshold; (5) predicting one or more projected rate values for a future point in time using an exponential equation; (6) generating a plot based upon the intercept, the slope, and the one or more projected rate values; (7) analyzing the plot to determine a range of projected rate values for the future point in time; and/or (8) outputting the range of projected rate values for the future point in time based upon the plot. The operations may include additional, less, or alternate functionality, including that discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts a diagram showing an exemplary architecture for a data-driven premium forecasting and ratemaking system that automates trend analysis, forecasting, and rate adjustment calculations, according to certain aspects of the disclosure.

FIG. 2A is an exemplary flowchart of a computer-implemented or computer-based process for predicting pure rate for one or more coverage programs, according to one or more embodiments.

FIG. 2B is an exemplary diagram that illustrates the processing of historical pure premium data, calculating error margins, and/or evaluating forecasting accuracy, according to one or more embodiments.

FIG. 2C is an exemplary diagram that illustrates forecasting premium values over multiple time horizons leveraging logarithmic transformation, exponential regression, and percentile-based adjustments, according to one or more embodiments.

FIG. 3 shows an exemplary machine-learning training flow chart, according to one or more embodiments.

FIG. 4 illustrates an implementation of an exemplary computer system that executes one or more techniques presented herein.

Advantages will become more apparent to those skilled in the art from the following description of the preferred embodiments that have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

The present embodiments may relate, inter alia, to computer systems and computer-implemented methods that may solve technical challenges by automating the forecasting of pure premiums using algorithmic modeling and exponential trend analysis, thereby enabling short-term projections with improved stability and accuracy. The system may leverage data transformation techniques, statistical calculations for exponential lines of best fit, and dynamic percentile-based selection methods to enhance responsiveness to recent trends while tempering overreaction. Additionally, the systems and methods may integrate machine-learning models at strategic stages to refine projections and optimize rate indications, allowing for scalable, real-time adjustments that improve time-to-market agility and adaptability to evolving market conditions.

Traditional methods for forecasting pure premiums may rely upon manual analyses of frequency and severity trends, followed by consultation with other users to determine rate indications. This process may be resource-intensive, and prone to human error, significantly slowing down time-to-market. The delayed rate filings may hinder the ability to respond swiftly to dynamic market conditions, leading to not accurately matching current price to current risk. Additionally, conventional methods may be constrained by longer projection horizons, which may increase prediction volatility and introduce greater uncertainty due to a dependence upon static historical data trends. These methods may lack the flexibility to incorporate recent developments or emerging market patterns, resulting in limiting adaptability and precision.

Conventional methods may use simplistic models that are linear in nature, making them inadequate for capturing complex, non-linear interactions among variables, such as economic indicators and policy changes. This oversimplification may lead to inaccuracies in rate projections. Additionally, these conventional techniques are often siloed, lacking integration with other data systems, which may hamper data consistency, scalability, and operational efficiency. The absence of advanced algorithmic modeling and dynamic data ingestion capabilities may restrict the optimization of profitability, competitiveness, and regulatory compliance.

Moreover, traditional systems and methods may be technically challenged regarding integrating machine-learning models due to rigid, rule-based frameworks and legacy data architectures. These systems and methods are not designed to handle large volumes of complex, multidimensional data, such as telematics or behavioral data, which are increasingly relevant to modern risk assessment. This limitation may hinder the ability to leverage advanced pattern recognition, feature importance analysis, and/or predictive analytics offered by machine-learning models, resulting in less accurate and less dynamic rate predictions. Conventional systems may also lack the capability for continuous learning from new data inputs, preventing real-time adjustments to shifting risk patterns and trends, or emerging variables.

### Exemplary Computer System

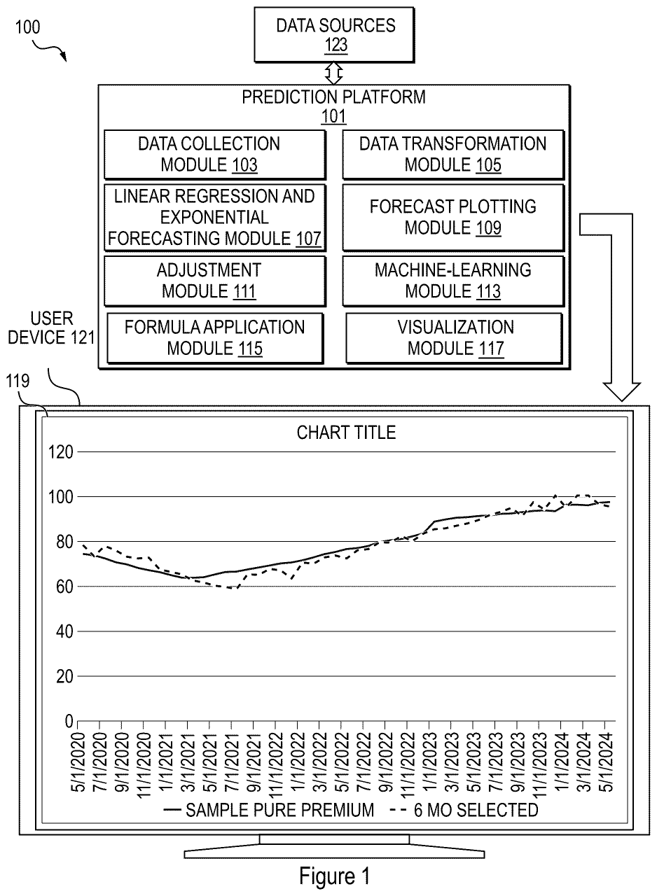

To address technical challenges, such as the above, system 100 of FIG. 1 may automate the forecasting of pure premiums through advanced algorithmic modeling and exponential trend analysis. Traditional methods may be limited by manual processes and long-term projections, leading to slower time-to-market and increased volatility in predictions. The system 100 may address these technical challenges by implementing a data-driven approach that may enhance prediction stability and accuracy through shorter-term forecasting. In one example, the system 100 may utilize a modular architecture that may systematically collect and transform rolling (e.g., 12-month) actual pure premium data, and apply natural logarithmic transformations to optimize trend detection and minimize noise in historical data.

The system 100 may calculate exponential lines of best fit using intercepts and slopes derived from the latest time periods. By dynamically projecting pure premiums for multiple future points using varying historical lengths (e.g., ranging from three months to five years), the system 100 may generate a comprehensive vertical plot of projected values. To ensure greater responsiveness to recent trends without overreacting to anomalies, the system 100 may apply a percentile-based selection method. This process may compare the most recent percentage changes in historical data to a distribution of historical changes, identify the corresponding percentile, and select a projected value that aligns with the percentile. This adaptive selection mechanism may balance trend sensitivity with predictive stability, effectively addressing the limitations of conventional rate-making methodologies.

The system 100 may integrate one or more machine-learning models at strategic stages to refine projections and enhance the forecasting accuracy. Historical and transformed pure premium data may be fed into the machine-learning algorithms to identify complex, non-linear patterns and dependencies that traditional methods might overlook. This data-driven approach may facilitate real-time adjustments, allowing the system 100 to recalibrate projections in response to emerging market dynamics. By enabling the seamless integration of continuous data inputs, the system 100 may provide scalable solutions for optimizing rate indications, improving profitability, competitiveness, and regulatory compliance. Consequently, this automated and intelligent system may revolutionize the rate-making process, resulting in significantly reducing the time-to-market, while also maintaining precision and adaptability to volatile market environments.

FIG. 1 depicts a diagram showing an exemplary architecture for a data-driven premium forecasting and ratemaking system that automates trend analysis, forecasting, and rate adjustment calculations, according to certain aspects of the disclosure. FIG. 1 may include the computing system 100 that may include a prediction platform 101, user devices 121, and data sources 123. It should be understood that other implementations of computing system 100 may omit one or more of the foregoing components and/or may include additional components, as the case may be.

In one instance, the prediction platform 101 may include a platform with multiple interconnected components. The prediction platform 101 may include one or more servers, intelligent networking devices, computing devices, components, and/or corresponding software for collecting, analyzing, transforming, and forecasting rate data, detecting patterns, refining predictions based upon new data, adjusting forecasts based upon market conditions, and/or applying necessary financial adjustments to generate accurate premium rate projections. For example, the prediction platform 101 may collect and analyze historical rate data, transforming it to identify trends and anomalies that may influence premium predictions. The prediction platform 101 may then generate forecasts for future premium values, taking into account both historical patterns and real-time market shifts, ensuring that projections remain relevant and adaptive. The prediction platform 101 may continuously learn from new data, allowing for the refinement of its forecast over time, providing increasingly accurate predictions as the prediction platform 101 ingests more information.

The prediction platform 101 may dynamically adjust forecasts based upon recent market conditions, balancing historical data with short-term trends to ensure premium predictions remain both responsive and stable. By applying actuarial formulas, the prediction platform 101 may integrate key financial factors such as profit, contingencies, and expense load, and may output the necessary adjustments to premium rates. This comprehensive approach may allow for faster and data-based decisions, as well as optimize the rate-setting processes to adapt quickly to changing market environments.

In one instance, prediction platform 101 may include a data collection module 103, a data transformation module 105, a linear regression and exponential forecasting module 107, a forecast plotting module 109, an adjustment module 111, a machine-learning module 113, a formula application module 115, and a visualization module 117, or any combination thereof. As used herein, terms such as “component” or “module” generally encompass hardware and/or software, e.g., that a processor or the like used to implement associated functionality. It is contemplated that the functions of these components are combined in one or more components or performed by other components of equivalent functionality.

In one instance, the data collection module 103 may gather and process, e.g., in real-time or near real-time, relevant data for forecasting pure premium values. The data collection module 103 may include various software applications (e.g., data mining applications in Extended Meta Language (XML)) that automatically search for and return the relevant data. The relevant data may be collected and processed by the system 100 if the users have consented to the use of their data for forecasting and rate adjustment purposes. In one example, the data collection module 103 may collect data (e.g., historical pure premium values, policy-level exposure data, claims information, economic indicators, industry benchmarks, real-time operational trends, etc.) from various data sources (e.g., data sources 123). By incorporating internal and external datasets, the data collection module 103 may provide a comprehensive view of factors influencing rate adjustments. The data collection module 103 may automate data extraction, ensuring continuous updates and validation to maintain data integrity.

Once collected, the data collection module 103 may employ advanced algorithms to clean and preprocess the data, ensuring that the data is in a suitable format for analysis. In one example, data cleansing may include removing or correcting erroneous data (e.g., redundant, incomplete, or incorrect data) to create high-quality data. The data cleansing technique may also include a data enhancement technique, where data may be made more complete by adding related information. In another example, the data preprocessing technique may include filtering out noise, handling missing values, and/or aggregating data to provide a comprehensive overview.

In one instance, data transformation module 105 may apply a logarithmic transformation to the collected data. The logarithmic transformation may include calculating the natural logarithm (log) of each data point, where such a transformation may compress large values and expand smaller ones, reducing overall variability in data. In one example, over a 12-month period, the pure premium data collected for an insurance policy may include:
Month 1: $1,000
Month 2: $1,200
Month 3: $5,000
Month 4: $20,000
Month 5: $50,000

In this dataset, the variability between the values increases significantly as the premium amount rises (e.g., the difference between $1,000 and $2,000 is smaller compared to the difference between $5,000 and $20,000). This may create a situation where the volatility is not constant and grows as the data value increases. By applying the logarithmic transformation, each value may be converted into its natural logarithm. The following illustrates the process of applying the natural log function to each data point:
Month 1: ln (1,000)≈6.91
Month 2: ln (1,200)≈7.09
Month 3: ln (5,000)≈8.52
Month 4: ln (20,000)≈9.90
Month 5: ln (50,000)≈10.82

After applying the logarithmic transformation, the data may become more compressed, and the range between values may decrease (e.g., the difference between 6.91 and 7.09 is similar to the difference between 8.52 and 9.90). Such a transformation may be useful for stabilizing the variance, improving the linearity of trends, and/or making the data more suitable for a regression analysis. By converting the raw values into the natural logarithms, the data transformation module 105 may ensure that the prediction platform 101 may capture exponential growth patterns more effectively, which may be useful for accurately predicting future premium values.

In one instance, the linear regression and exponential forecasting module 107 may leverage statistical techniques to model the relationship between historical pure premium data and time, enabling accurate projections for future periods. The linear regression and exponential forecasting module 107 may perform a linear regression analysis to determine the slope and intercept for the most recent data period (e.g., the last three months). The slope may indicate the rate of change in the data, while the intercept may represent the value of the data at the starting point (time zero). By applying linear regression to recent data, the linear regression and exponential forecasting module 107 may create a foundational estimate of the trends within that short window. This may facilitate capturing recent developments or fluctuations in the data, ensuring that the prediction platform 101 is responsive to the most up-to-date patterns.

The linear regression and exponential forecasting module 107 may use the output from the linear regression (slope and intercept) to generate an exponential best-fit curve. This curve may be useful in scenarios where the data exhibits exponential growth or decay over time. Exponential forecasting may assume that changes in the data are proportional to the current value, which is suitable insurance premiums, where rates often increase or decrease at accelerating or decelerating rates rather than a constant linear rate. The exponential curve may be defined by the following formula:

$$y = e \hat{} ( slope * x ) * e \hat{} intercept$$

where y is the predicted future value, x is the time period in the future (e.g., six months), and the slope and the intercept are derived from the most recent data.

To enhance the accuracy of the forecast, the linear regression and exponential forecasting module 107 may extend the analysis beyond a short (e.g., 3-month) window. The linear regression and exponential forecasting module 107 may leverage historical data windows ranging from 3 months to 5 years. By using progressively larger windows of data, the linear regression and exponential forecasting module 107 may account for longer-term trends and potential cycles that may not be immediately evident in the short term. This multi-window approach may generate a vertical stack of forecasts, with each forecast representing a different time window. The forecast stack may provide a range of possible future outcomes, allowing for more informed decision-making when setting premium rates.

The use of both linear regression for short-term forecasting and exponential forecasting for capturing long-term trends may ensure that the prediction platform 101 provides reliable and stable predictions. By integrating data over varying time windows and applying statistical techniques that account for both recent fluctuations and longer-term behaviors, the linear regression and exponential forecasting module 107 may produce highly accurate forecasts, which may be useful for making timely rate adjustments and responding to changing market conditions.

Once the exponential best-fit curve and associated forecast values are generated by the linear regression and exponential forecasting module 107, the forecast plotting module 109 may take these projections and plot them upon a graph for easier interpretation and analysis. The forecast plot may typically display time (x-axis) against the projected pure premium value (y-axis), with different forecasted points representing future time periods, such as 6 months, 12 months, and 24 months ahead.

In one instance, the vertical stack of forecasts, generated from using various historical data windows (e.g., from 3 months to 5 years) may also be incorporated into the forecast plot. This stack may provide a range of possible outcomes, showing different projected pure premium values depending upon the data window used in the analysis. The forecast plot may provide a clear visual representation of the potential trends and variability in the forecasted premiums, helping decision-makers understand how the future may evolve based upon current and historical data. The graph may also highlight critical intervals where the rate projections may experience significant fluctuations or stability, enabling more informed rate-setting and planning.

In addition, the forecast plot may incorporate confidence intervals and variance analysis. Confidence intervals may provide a range of potential values within which the forecasted pure premium is likely to fall, giving decision-makers a sense of variability in the projections. Variance analysis may further quantify this uncertainty by comparing the forecasted values to actual data, helping to identify any significant discrepancies or deviations over time. Such a visual representation, complete with multiple forecast horizons and uncertainty quantification, may facilitate data-driven decisions.

In one instance, the adjustment module 111 may refine forecasted pure premiums by applying percentile-based adjustments derived from historical monthly changes. This may ensure that the final selection is both responsive to recent trends and tempered by long-term historical patterns. The adjustment module 111 may calculate month-over-month percentage changes in pure premium values over a historical period, and may determine where the most recent monthly changes fall within this distribution. Based upon the identified percentile, the prediction platform 101 may select a projected premium value from the range of forecasted values, ensuring that the final selection aligns with historical patterns while adapting to emerging market conditions.

The adjustment module 111 may apply weighting techniques that integrate both recent and long-term historical data. By assigning a greater weight to more recent observations while still factoring in long-term trends, the adjustment module 111 may prevent overreliance upon short-term fluctuations while ensuring timely responsiveness to evolving market conditions. Additionally, the adjustment module 111 may allow for dynamic calibration, where the weight distribution may be adjusted based upon external market indicators. Accordingly, the adjustment module 111 may ensure that the final projected premium value reflects an optimal balance between historical stability and real-time adaptability.

In one instance, the machine-learning module 113 may enhance the forecasting pipeline by ingesting transformed rate data to detect complex patterns, trends, and anomalies that may not be easily captured through traditional statistical techniques. By leveraging historical and real-time data, the machine-learning module 113 may identify underlying relationships between pure premium changes, claim frequency and severity trends, external economic indicators, and other market variables. This may allow for a more nuanced understanding of premium fluctuations, enabling the prediction platform 101 to refine predictions dynamically as new data becomes available.

The machine-learning module 113 may continuously learn from new data, adapting to evolving market conditions and improving forecasting accuracy over time. The machine-learning module 113 may be trained upon historical premium data, incorporating rolling updates as fresh data is ingested. By analyzing deviations between predicted and actual premium values, the prediction platform 101 may fine-tune model parameters, reducing forecasting errors and enhancing predictive stability. The machine-learning module 113 may identify outliers or unexpected shifts in rate patterns, which may signal market disruptions, fraud detection opportunities, or structural changes in loss trends.

To enhance decision-making, the machine-learning module 113 may generate confidence scores for projected premium values, quantifying the reliability of each forecast. These confidence scores may allow decision-makers to assess the level of certainty associated with premium predictions and adjust ratemaking strategies accordingly. Additionally, the machine-learning module 113 may incorporate dynamic weighting techniques, adjusting the influence of historical versus recent data based upon real-time market conditions. For instance, during periods of economic volatility, the prediction platform 101 may assign greater weight to recent trends, whereas in stable periods, long-term historical data may have a stronger influence. By integrating advanced analytics, continuous learning, and dynamic adjustments, the machine-learning module 113 may ensure that the forecasting pipeline remains adaptable, data-driven, and highly responsive to changing market conditions.

In one instance, the formula application module 115 may integrate the projected premium values into established ratemaking formulas to determine the indicated percent change in actual premium data. Once the prediction platform 101 generates the final projected pure premium values, adjusted for recent trends and historical influences, it is applied to one or more actuarial formulas that may account for key financial considerations, including profit margins, expense load, and anticipated premium levels.

The formula application module 115 may compute the indicated percent change in actual premium data by comparing the projected pure premium to historical values and adjusting for external factors, such as inflation, regulatory requirements, and market conditions. By applying structured formulas, the formula application module 115 may quantify the necessary adjustments to premium rates, enabling decision makers to make data-driven pricing decisions. The output of this module may provide a clear recommendation upon rate adjustments, allowing for faster decision-making and regulatory filings.

In one instance, the visualization module 117 may present complex forecasting and premium data in an intuitive and actionable manner. The visualization module 117 may translate the raw results from various modules, such as projected premium values and percent changes, into a clear and easy-to-understand visual representation. The visualization module 117 may employ various application programming interfaces (APIs) or other function calls corresponding to the application upon the user device 121, thus enabling the display of graphics primitives such as graphs, edges, icons, menus, buttons, data entry fields, (e.g., user interfaces 119 in user device 121). These user interfaces 119 may include trend lines, graphs, and charts that display the forecasted pure premiums over different time horizons (e.g., 6 months, 9 months, etc.), enabling users (e.g., decision-makers) to quickly grasp the projected premium trends and their potential implications.

The visualization module 117 may also comprise a variety of interfaces, for example, interfaces for data input and output devices, referred to as I/O devices, storage devices, and the like. Still further, the visualization module 117 may be configured to operate in connection with augmented reality (AR) processing techniques, wherein various applications, graphic elements, and features interact. By visually displaying the range of possible outcomes, along with the associated probabilities, the visualization module 117 may allow the users to assess the reliability of the predictions and make informed decisions. For example, the type of visualizations may include:
(i) heat maps: which may highlight areas of high or low premium variations;
(ii) box plots: which may illustrate the distribution of forecasted values; and/or
(iii) scatter plots: which may show the relationship between historical data points and forecasted premiums.

These visualizations may enable users to explore the underlying data in more detail, offering dynamic filtering options for deeper analysis.

In one instance, the user device 121 may include, but is not restricted to, any type of mobile terminal, wireless terminal, fixed terminal, or portable terminal. Examples of the user device 121 may include hand-held computers, desktop computers, laptop computers, wireless communication devices, cell phones, smartphones, mobile communications devices, a Personal Communication System (PCS) device, tablets, server computers, gateway computers, or any combination thereof, including the accessories and peripherals of these devices, or any combination thereof.

In one instance, data sources 123 may include a variety of data sources that may provide comprehensive and contextually relevant data. The data sources 123 may provide the essential input data for transforming, analyzing, and forecasting future premium values. Commonly, data may be collected from historical premium data that may include paid loss, loss adjustment expenses, and exposure data across multiple coverage types (e.g., bodily injury (BI), property damage (PD), comprehensive (COMP), and collision (COLL)).

The data sources 123 may also include external data sources, such as market conditions, economic indicators, regulatory changes, and industry benchmarks. These external data sources may help account for larger macroeconomic influences and ensure that the forecasts align with broader trends in the insurance and financial market. The data sources 123 may also include actuarial databases, claims data, and customer-specific data (e.g., demographic information, policyholder behavior, etc.), which may refine the projections for specific segments. By incorporating these elements from the data sources 123, the computing system 100 may ensure that diverse, high-quality data are available. It should be understood that data sources 123 may include any other databases that provide relevant information.

The various elements of the computing system 100 may communicate with each other through a communication network. In one instance, the user device 121 may include a network detection sensor for detecting wireless signals or receivers for different communications (e.g., Bluetooth, Wi-Fi, Li-Fi, near field communication (NFC), etc.) from the communication network. The communication network may support a variety of different communication protocols and communication techniques.

In one instance, the communication network may allow the user device 121 (or one or more user devices) to communicate with the prediction platform 101. The communication network may include one or more networks such as a data network, a wireless network, a telephony network, or any combination thereof. It is contemplated that the data network is any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network is, for example, a cellular communication network and employs various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof.

The above presented modules and components of the prediction platform 101 may be implemented in hardware, firmware, software, or a combination thereof. Though depicted as a separate entity in FIG. 1, it is contemplated that the prediction platform 101 may be implemented for direct operation by the respective user device 121. As such, the prediction platform 101 may generate direct signal inputs by way of the operating system of the user device 121. In one instance, one or more of the modules 103-117 may be implemented for operation by the respective user device 121, as the prediction platform 101. The various executions presented herein contemplate any and all arrangements and models.

### Exemplary Data Analysis and Prediction Flowchart

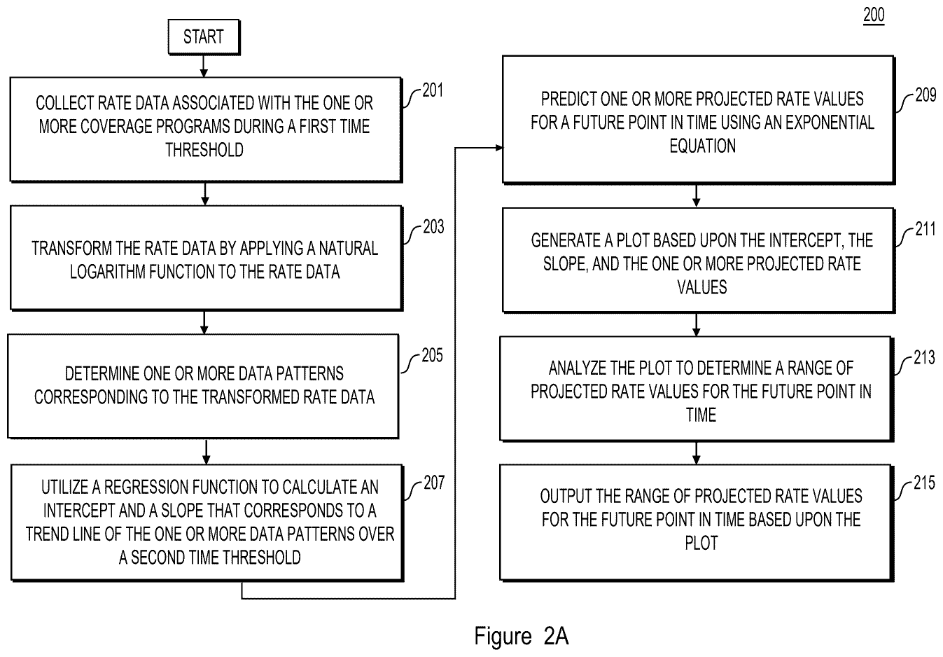

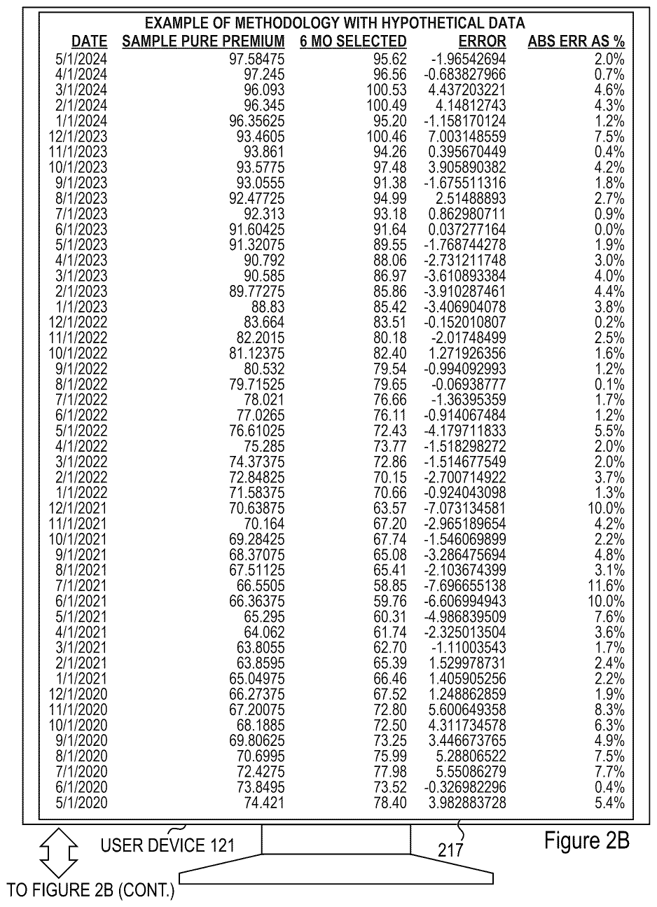

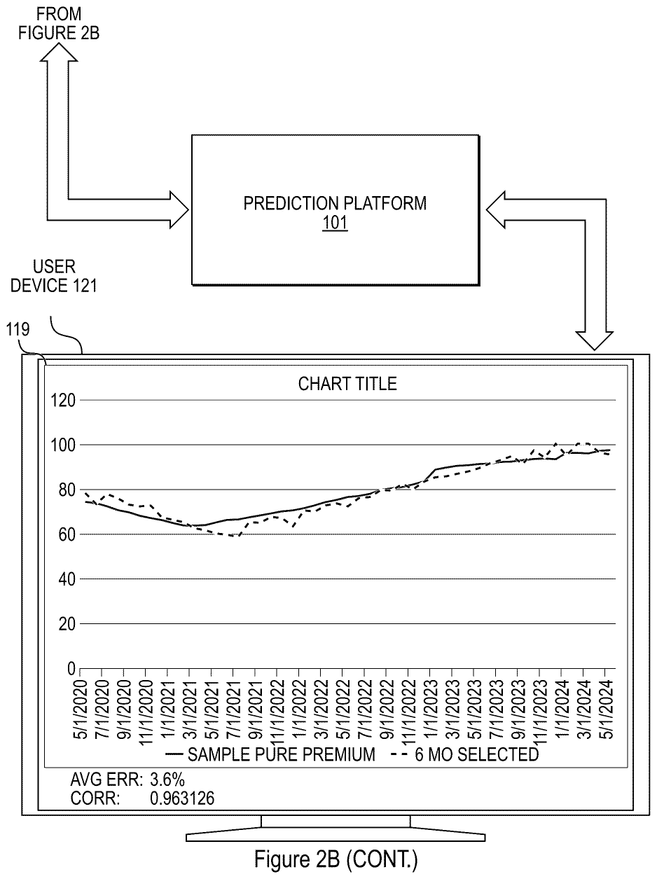

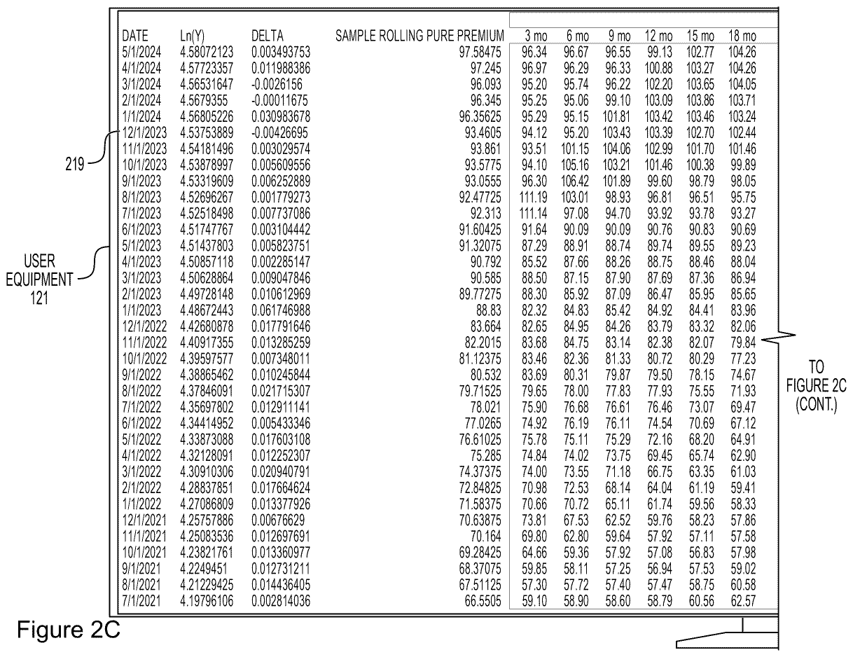

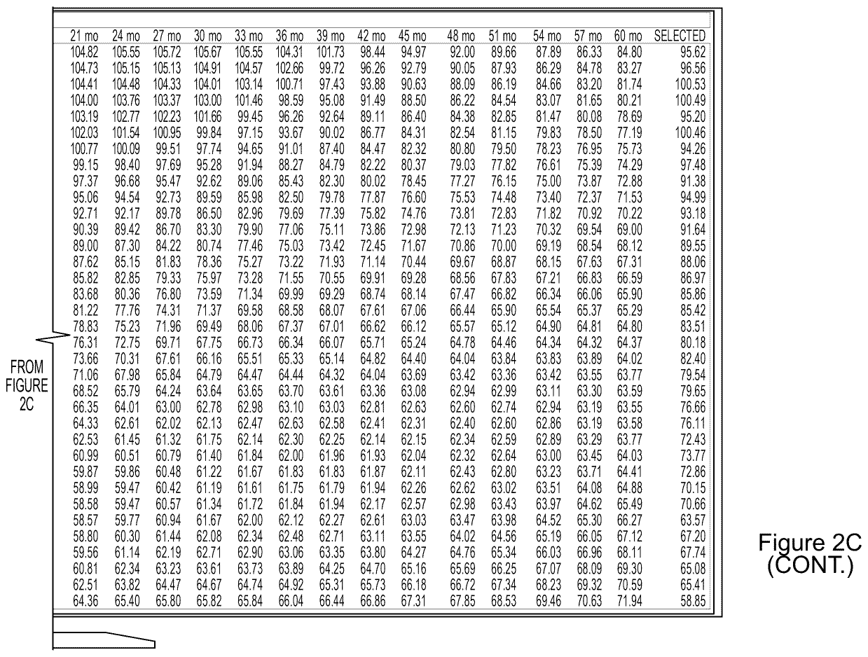

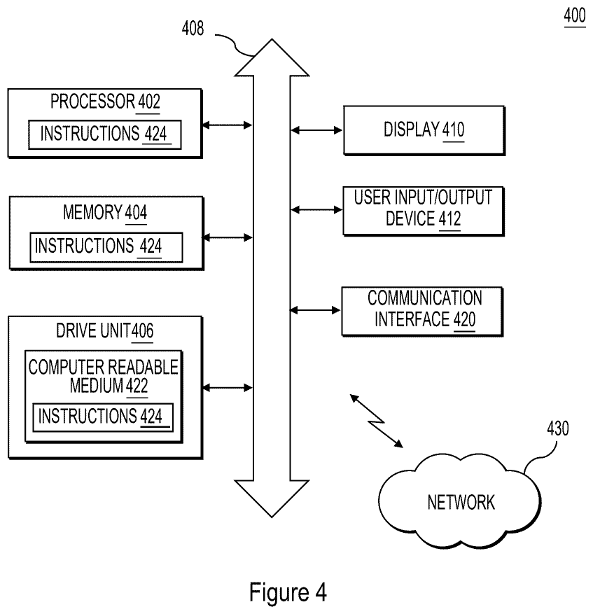

FIG. 2A is an exemplary flowchart of a computer-implemented or computer-based process for predicting a pure rate (e.g., pure premium) for one or more coverage programs (e.g., insurance programs). In one instance, the prediction platform 101 and/or any of the modules 103-117 may perform one or more portions of the process 200 and are implemented using, for instance, a chip set including a processor (e.g., processor 402) and a memory (e.g., memory 404), as shown in FIG. 4. As such, the prediction platform 101 and/or any of the modules 103-117 may be configured to facilitate accomplishing various parts of the process 200, as well as accomplishing embodiments of other processes described herein in conjunction with other components of the computing system 100. Although the process 200 is illustrated and described as a sequence of actions, operations, and/or functionality, it is contemplated that various embodiments of the process 200 may be performed in any order or combination and need not include all of the illustrated actions, operations, and/or functionality.

In block 201, the prediction platform 101 may collect rate data (e.g., actual pure premium) associated with one or more coverage programs (e.g., insurance programs) during a first time threshold. The actual pure premium may refer to the amount users (e.g., policyholders) pay for insurance coverage. The insurance programs may include auto insurance programs, homeowners insurance programs, commercial liability insurance programs, and so on. The first time threshold may refer to an initial period (e.g., the first 3-month after launching a new insurance product) during which the prediction platform 101 may capture and analyze actual pure premiums to establish baseline trends and/or patterns.

In one instance, the prediction platform 101 may calculate a ratio corresponding to loss data (e.g., incurred losses) and loss adjustment data divided by a covered unit quantity for each of the one or more coverage programs. The rate data may correspond to this ratio. The incurred losses may represent financial obligations of the insurance company to policyholders for covered losses, such as the total amount paid by the insurance company for claims, including both settled and outstanding claims. The loss adjustment data may include costs associated with investigating, processing, and settling claims, such as administrative expenses. The covered unit quantity may represent the exposure base used for normalizing losses, which may vary depending upon the type of insurance. For example, in auto insurance programs, the unit may correspond to the number of vehicles insured for one full year. For instance, in property insurance programs, the unit may correspond to the insured property value.

In block 203, the prediction platform 101 may transform the collected rate data by applying a natural logarithm function to the rate data. In one instance, applying a natural logarithm function may include replacing each data point with its logarithmic value based upon the mathematical function In (x), where x may be the rate data. This transformation may convert the rate data into a logarithmic scale, which may stabilize variance, linearize trends, and improve the interpretability of data for forecasting.

In one instance, the prediction platform 101 may associate each transformed rate data with a corresponding time value representing a collection time period. The transformed rate data may include one or more y-values corresponding to one or more changes in the rate data, such as fluctuations in premiums due to various factors like market conditions or policy adjustments. The corresponding time value may include one or more x-values corresponding to a time period sequence. The x-values may typically follow a consistent time interval (e.g., monthly, or quarterly) and serve as the time axis for the data. This pairing may allow the prediction platform 101 to track how rate changes evolve over time and may facilitate the application of analytical techniques, such as a regression analysis.

In block 205, the prediction platform 101 may determine data patterns corresponding to the transformed rate data. In one instance, the data patterns may include recurring trends, cycles, or anomalies that emerge when observing the rate data. For example, the data pattern may reveal that a premium tends to rise during certain months due to higher claim frequencies or market conditions. For example, the data pattern may reveal a cyclical trend where rates increase every few years due to regulatory changes.

In block 207, the prediction platform 101 may utilize a regression function to calculate an intercept and a slope that correspond to a trend line of one or more data patterns over a second time threshold. In one instance, the regression function may analyze the transformed rate data, where the x-values may represent time intervals, and the y-values may represent corresponding rate data at those intervals. The intercept may indicate the starting value of the trend line (i.e., the estimated rate data at time zero), while the slope may show the direction and steepness of the trend, indicating how the rate data is changing over time. By applying the regression function, the prediction platform 101 may generate a mathematical representation of the data's underlying trend, which may help in predicting future rate behavior.

In block 209, the prediction platform 101 may predict one or more projected rate values for a future point in time using an exponential equation. In one instance, prediction platform 101 may apply the intercept and the slope to an exponential model for a future point in time. Specifically, the prediction platform may apply the formula (e\hat{ }(slope*x))*(e\hat{ }intercept), wherein x may represent the number of time periods into the future for which the predictions are being made. The equation may capture the nature of exponential growth or fall in the rate data. Then, the prediction platform 101 may generate an exponential line reflecting the patterns for the transformed rate data during an additional time threshold. This may enable the prediction platform 101 to provide more accurate forecasts of premium accounting for both short-term variation and long-term tendencies.

In block 211, the prediction platform 101 may generate a plot based upon the intercept, the slope, and/or one or more projected rate values. In one instance, the prediction platform 101 may iterate the process of (i) calculating the intercept and the slope and (ii) predicting the projected rate value for a pre-determined time interval (e.g., 3 months to 5 years) to refine the projections. The projected points may be plotted upon a vertical graph, creating a visual representation of exponential lines of best fit for each time period. As the time window expands from shorter to longer periods, the plot may display multiple projections based upon various data windows, enabling the prediction platform 101 to capture different trends and cycles over time. This iterative process may result in a comprehensive plot that may reflect how rate values may evolve over time, offering a more accurate and dynamic forecasts that adapt to both short-term fluctuations and long-term trends.

In block 213, the prediction platform 101 may analyze the plot to determine a range of projected rate values for the future point in time. This may include assessing the exponential lines of best fit created from the multiple time periods, and identifying the spread of projected values based upon different historical data windows. By considering the trends, slopes, and intercepts across these projections, the prediction platform 101 may determine a reasonable range of possible outcomes.

In block 215, the prediction platform 101 may output the range of projected rate values for the future point in time based upon the analyzed plot. In this instance, the prediction platform 101 may calculate ratio changes (e.g., percentage changes) in the rate data between preconfigured time intervals, assessing how much the rate has changed over those periods. The prediction platform 101 may determine a rank of the calculated ratio changes by (i) ordering the ratio changes, and (ii) identifying a rank for the ratio changes. The prediction platform 101 may select at least one projected rate value from the one or more projected rate values for the future point in time based upon the rank. The selected projected rate value may be applied to one or more functions to determine a change in the rate data.

In one instance, the prediction platform 101 may input the transformed rate data, the range of projected rate values, and historical rate data into a trained machine-learning model to enhance the accuracy of the forecast. The trained machine-learning model may process these inputs by analyzing patterns and relationships between the transformed data, the projected values, and past trends. By learning from historical rate fluctuations, the trained machine-learning model may identify underlying factors that influence rate changes and detect complex patterns in the data. The trained machine-learning model may utilize this knowledge to predict one or more future rate values, offering precise, data-driven projections that may account for historical behavior and emerging trends.

In one instance, the trained machine-learning model may update one or more weights and one or more parameters based upon the transformed rate data, the range of projected rate values, and the historical rate data. The weights and parameters may include values that dictate how much influence certain data points or features have upon the trained machine-learning model's predictions. By continuously processing these inputs, the trained machine-learning model may learn from new data and may adjust its weights and parameters to accurately capture the underlying terms and patterns in the rate data. Such a dynamic adjustment may help the trained machine-learning model adapt to market fluctuations and provide better forecasts.

In one instance, the prediction platform 101 may generate, via the trained machine-learning model, a confidence score for each of one or more future rate values. The confidence score may indicate the level of certainty or reliability in the predicted rate values. Based upon the confidence score, the prediction platform 101 may adjust ratio changes in the rate data, either giving more weight to the predicted value when the confidence is high or applying more caution when the confidence is low. This adjustment may ensure the rate projections are reflective of the model's certainty.

In one instance, the prediction platform 101 may receive, via the trained machine-learning model, feedback from one or more prior projections. Based upon the feedback, the prediction platform 101 may initiate a retraining process for the machine-learning model. During the retraining, the machine-learning model's weights and parameters are adjusted and refined to improve its accuracy, particularly in predicting future rate values. This retraining process may facilitate the machine-learning model to learn from past errors and incorporate new patterns in the data.

### Exemplary Data Processing, Forecasting, and Accuracy Assessment

FIG. 2B is an exemplary diagram that illustrates the processing of historical pure premium data, calculating error margins, and/or evaluating forecasting accuracy, according to one or more embodiments. In one instance, table 217 may present a structured methodology that the prediction platform 101 may utilize to analyze and forecast premium values over time. The prediction platform 101 may process historical premium data by transforming the raw data (e.g., sample pure premium values) to ensure consistency in trend analysis. The prediction platform 101 may then apply the various statistical and forecasting techniques to generate projected values (e.g., the 6-month selected period), which may represent the forecasted premium values over a time window (e.g., a six-month window). These projected values may be generated based upon a rolling analysis of previous months' trends and adjustments for volatility. The prediction platform 101 may evaluate the accuracy of these projections by calculating the deviation (e.g., errors) as the difference between actual and predicted values. The prediction platform 101 may quantify the magnitude of these errors (e.g., absolute error as a percentage) for performance monitoring and refinement.

Table 217 may include five columns that illustrate the relationship between actual premium values and forecasted values using a rolling 6-month predictive selection approach. It should be understood that table 217 may include additional columns, as the case may be. The columns may include:
(i) Date: this column may provide a structured timeline for premium data, recorded upon a monthly basis in descending order, beginning from May 1, 2024, and going back to May 1, 2020. This chronological organization may allow for historical tracking and trend analysis, enabling the prediction platform 101 to analyze fluctuations over time and assess forecasting accuracy. Each row may represent one month's data, maintaining a consistent frequency that may facilitate time-series analysis. The dataset may capture premium trends over four years, allowing the prediction platform 101 to identify both long-term patterns and short-term fluctuations.
(ii) Sample Pure Premium: This column may record the actual observed pure premium values for each month. The values may fluctuate over time due to various reasons, such as claims experience, economic inflation, regulatory changes, and/or shifts in risk exposure. For instance, examining the data over the four-year period from May 1, 2020, to May 1, 2024, a steady upward trend is observed:
   May 1, 2020: 74.421
   Jun. 1, 2020: 73.8495
   . . .
   Mar. 1, 2024: 96.093
   Apr. 1, 2024: 97.245
   May 1, 2024: 97.58475
This increasing pattern may suggest that pure premiums have risen over the given timeframe. Despite the general upward trend, short-term fluctuations are evident. For instance, in some months, the pure premium value slightly declined before rebounding. These actual values may serve as the benchmark against which predictive models may be evaluated.
(iii) 6-month selected (forecasted) value: This column may represent forecasted values for each month, generated based upon a rolling 6-month window. The prediction platform 101 may select a projected premium value by analyzing historical patterns and adjusting for recent trends. This approach may allow for a balanced weighting of both short-term variations and long-term stability in premium values. In one instance, the prediction platform 101 may integrate multiple statistical techniques, such as linear regression, exponential smoothing, and machine-learning driven adjustments to determine the most probable premium value. The prediction platform 101 may dynamically adapt its predictions by giving more weight to recent months where trends appear to shift significantly while maintaining consistency with historical data.
   For example, the prediction platform 101 may forecast the May 1, 2024, premium as 95.62, whereas the actual value was 97.58475, indicating the premium value was underpredicted for this period. Conversely, for Mar. 1, 2024, the prediction platform 101 may forecast a premium of 100.53 which is higher than the actual premium value of 96.093, indicating the premium value was overpredicted for this period. Over time, the prediction platform 101 may refine its forecasts by comparing past predictions to actual results, adjusting its weightings dynamically. This process may improve accuracy and responsiveness to emerging premiums.
(iv) Error: This column may capture the difference between the actual sample pure premium and the 6-month selected (forecasted) value for each month. This metric may provide insight into how accurate the predictive model is performing, helping to assess whether it overestimates or underestimates premium values. A negative error may indicate an underestimation of the premium, whereas a positive error may show an overestimation. For example, upon May 1, 2024, the error was −1.96542694, meaning the predicted premium was slightly lower than the actual value. For Mar. 1, 2024, the error was 4.437203221, indicating an overprediction of the premium.
   By tracking these errors, the prediction platform 101 may track biases in the forecasts (e.g., consistently overestimating or underestimating in certain periods), adjust weighing mechanisms in the prediction model to place more emphasis upon recent trends or historical patterns, and/or improve forecasting by incorporating machine-learning adjustments to reduce error over time.
(v) Absolute error as a percentage: This column may normalize the error by expressing it as a percentage of the actual premium value. This may provide a relative measure of forecasting accuracy. A lower percentage may indicate higher accuracy, meaning the predicted premium closely aligns with the actual pure premium, whereas a higher percentage may indicate greater deviation and lower predictive accuracy.
   For instance, for Apr. 1, 2020, the absolute error as a percentage was 5.4%, suggesting a less accurate prediction for that month. Whereas, for Apr. 1, 2024, the absolute error as a percentage was 0.7%, indicating a high accuracy in prediction for that month. This metric may help assess the reliability of the forecasting model.

The prediction platform 101 may present this data in an interactive chart-based visualization upon a user interface 119 of the user device 121. The user interface 119 may include:
(i) Time-series line graph: showing actual versus predicted premium values over time, highlighting divergence;
(ii) Error trend analysis: a bar graph or heat map depicting the monthly errors and deviations in premium predictions;
(iii) Confidence and variance visualization: a shaded region around the trend lines indicating uncertainty and confidence intervals; and/or
(iv) Dynamic drill-down and filtering: allowing users to analyze specific time periods, adjust forecast horizons, and compare historical versus predicted trends.

Through these visual tools, users may evaluate prediction accuracy, detect anomalies, and refine pricing strategies.

### Exemplary Time-Series Analysis for Pure Premium Estimation

FIG. 2C is an exemplary diagram that illustrates forecasting premium values over multiple time horizons leveraging logarithmic transformation, exponential regression, and percentile-based adjustments, according to one or more embodiments. By analyzing historical trends, calculating rate changes through logarithmic differentials, and applying rolling window regressions, the prediction platform 101 may identify patterns in premium fluctuations. Additionally, the prediction platform 101 may leverage percentile-based selection techniques and trend adjustments to refine its forecasting accuracy. These calculations may facilitate the prediction platform 101 to assess risk trajectories, detect anomalies, and optimize premium projections for informed decision-making.

In this example, table 219 may include several columns each representing different steps in the forecasting methodology, such as:
(i) Date: This column may list monthly timestamps in descending order, starting from May 1, 2024, down to Jun. 1, 2021. This structured sequence may provide a historical framework for analyzing premium trends over time. It may enable the prediction platform 101 to organize data chronologically, ensuring that all calculations, such as trend analysis, percentile-based selections, and/or regression-based forecasts, are anchored to a consistent temporal reference. By maintaining a structured timeline, the prediction platform 101 may track changes in pure premium values, compute historical patterns, and align forecasts across different lookback periods (e.g., 3 months, 6 months, 12 months, 60 months, and so on). This date column may also ensure that rolling window computations and error assessment remain synchronized with the actual sequence of premium developments, allowing for precise trend identification and forecasting accuracy.
(ii) Ln(Y): This column may represent the natural logarithm of the rolling 12-month pure premium for each corresponding date. This transformation may be applied to stabilize variance, normalize fluctuations, and enhance the suitability of the data for regression modeling. By converting raw premium values into the logarithmic equivalents, the prediction platform 101 may ensure that exponential growth or decay patterns in premium trends may be effectively identified and analyzed.
(iii) Delta: This column may represent the percentage change in the natural logarithm (Ln) of the sample pure premium between current and previous periods. It may be calculated as:

$$Δ = \frac{ln ( Y ) current}{ln ( Y ) previous} - 1$$

Where:
Ln(Y) current may refer to the natural logarithm of the sample pure premium for the current period (e.g., May 1, 2024).
Ln(Y) previous may refer to the natural logarithm of sample pure premium for the previous period (e.g., Apr. 1, 2024).
By focusing upon the difference between the logarithm values, the Delta column may facilitate the prediction platform 101 to neutralize any exponential growth or shrinkage, offering a more consistent measurement of change.
(iv) Sample Rolling pure premium (e.g., 12 months): This column may represent the raw, untransformed premium values observed over a rolling 12-month period. These values may track the historical movements of pure premium, providing insight into how premiums have fluctuated month-to-month and year-to-year. By examining this data, the prediction platform 101 may gain a better understanding of premium trends, which may be crucial for identifying any shifts in claims costs or market conditions. This column may serve as a baseline for comparison with forecasted premium values, helping validate the accuracy of the prediction by ensuring that predicted premiums align with the actual historical data.
(iv) Forecasting (3-month to 60-month projections): These columns may represent exponential regression forecasts based upon historical data, allowing the prediction platform 101 to evaluate how the premium may likely change over time. In this example, there are 20 columns, each for a specific time horizon, ranging from 3-month all the way to 60-month. The formula used for farecasting may be:

$$exp ( Slope ( Ln ( y ) ) * Date + Intercept ( Ln ( Y ) ) )$$

Where:
Slope (Ln(y)) may include the slope of the regression line that best fits the natural logarithm of the pure premium values.
Date may represent the x-axis of the regression model.
Intercept (Ln(Y)) may include the intercept of the regression with the y-axis, and represents the value of Ln(Y) at time 0 (or at the starting point of the trend). The intercept may indicate the base level of the pure premium before accounting for any changes in the data over time.
Exp (exponential function) may be used to reverse the natural logarithmic transformation of the pure premium values.
The Forecasting (3-month to 60-month projections) columns may generate future premium values at different time horizons. By using exponential regression, the prediction platform 101 may generate projections of how the pure premium may evolve over time, allowing for short-term (e.g., 3 to 12 months) and long-term (e.g., 24 to 60 months) predictions. By examining the projections across these time horizons, the prediction platform 101 may detect patterns, such as stability, growth, or decline.
(v) Selected: This column may utilize a percentile-based selection method to adjust the forecasted premium values based upon recent trends captured by the Delta column. The formula may be:

percentile(forecast vlaues,percent rank(delta))
Where:
Forecast values may include the predicted premium values for different time horizons (e.g., 3 months, 6 months, 9 months, etc.).
Percent rank (Delta) may calculate the rank of the current month's Delta value (the rate of change in the Ln(Y) value) as a percentage of all Delta values from the historical data.
The percentile-based selection helps in selecting the most probable premium projection by adjusting the forecast values according to how the current Delta compares to past trends. This may reduce the potential for outlier biases and may improve the reliability of the forecast.

### Exemplary Machine-Learning Techniques

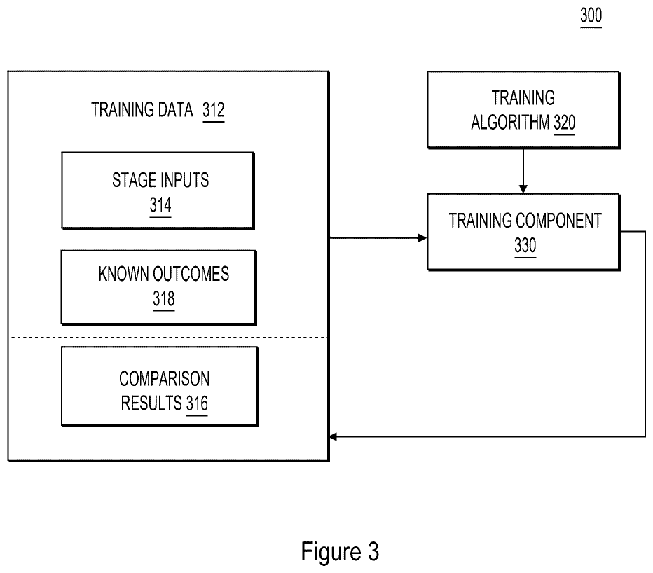

One or more implementations disclosed herein may include and/or may be implemented using a machine-learning model. For example, one or more of the modules of the prediction platform 101 may be implemented using a machine-learning model and/or may be used to train the machine-learning model. A given machine-learning model may be trained using the data flow 300 of FIG. 3. Training data 312 may include one or more of stage inputs 314 and known outcomes 318 related to the machine-learning model to be trained. The stage inputs 314 may be from any applicable source including text, visual representations, data, values, comparisons, stage outputs, e.g., one or more outputs from one or more actions or operations from FIGS. 2A-2C. The known outcomes 318 may be included for the machine-learning models generated based upon supervised or semi-supervised training. An unsupervised machine-learning model may not be trained using known outcomes 318. Known outcomes 318 may include known or desired outputs for future inputs similar to, or in the same category as, stage inputs 314 that do not have corresponding known outputs.

The training data 312 and a training algorithm 320, e.g., one or more of the modules implemented using the machine-learning model and/or may be used to train the machine-learning model, may be provided to a training component 330 that may apply the training data 312 to the training algorithm 320 to generate the machine-learning model. According to an implementation, the training component 330 may be provided comparison results 316 that compare a previous output of the corresponding machine-learning model to apply the previous result to re-train the machine-learning model. The comparison results 316 may be used by training component 330 to update the corresponding machine-learning model. The training algorithm 320 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, models specifically discussed in the present disclosure, or the like.

The machine-learning model used herein may be trained and/or used by adjusting one or more weights and/or one or more layers of the machine-learning model. For example, during training, a given weight may be adjusted (e.g., increased, decreased, removed) based upon training data or input data. Similarly, a layer may be updated, added, or removed based upon training data/and or input data. The resulting outputs may be adjusted based upon the adjusted weights and/or layers.

In general, any process or operation discussed in this disclosure is understood to be computer-implementable, such as the processes illustrated in FIGS. 1-2C may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

### Exemplary Computing Environment

In general, any process or operation discussed in this disclosure is understood to be computer-implementable, such as the processes illustrated in FIGS. 1-2C and may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

FIG. 4 illustrates an implementation of a computer system that may execute techniques presented herein. The computer system 400 may include a set of instructions that can be executed to cause the computer system 400 to perform any one or more of the methods or computer based functions disclosed herein. The computer system 400 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 400 may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a Personal Digital Assistant (PDA), a mobile device, a palmtop computer, a laptop computer, a desktop computer, a web appliance, or any other machine capable of executing a set of instructions (sequential or otherwise) that specify actions to be taken by that machine. In a particular implementation, the computer system 400 may be implemented using electronic devices that provide voice, video, or data communication. Further, while the computer system 400 is illustrated as a single system, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a Central Processing Unit (CPU), a Graphics Processing Unit (GPU), or both. The processor 402 may be a component in a variety of systems. For example, the processor 402 may be part of a standard personal computer or a workstation. The processor 402 may be one or more processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 may include a cache or random-access memory for the processor 402. In alternative implementations, the memory 404 is separate from the processor 402, such as a cache memory of a processor, the system memory, or other memory.

The memory 404 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the processor 402 executing the instructions stored in the memory 404. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 400 may further include a display 410, such as a liquid crystal display (LCD), an organic light emitting diode (OLED), a flat panel display, a solid-state display, a cathode ray tube (CRT), a projector, a printer or other now known or later developed display device for outputting determined information. The display 410 may act as an interface for the user to see the functioning of the processor 402, or specifically as an interface with the software stored in the memory 404 or in the drive unit 406.

Additionally or alternatively, the computer system 400 may include an input/output device 412 configured to allow a user to interact with any of the components of the computer system 400. The input/output device 412 may be a number pad, a keyboard, or a cursor control device, such as a mouse, or a joystick, touch screen display, remote control, or any other device operative to interact with the computer system 400.

The computer system 400 may also or alternatively include drive unit 406 implemented as a disk or optical drive. The drive unit 406 may include a computer-readable medium 422 in which one or more sets of instructions 424, e.g., software, can be embedded. Further, instructions 424 may embody one or more of the methods or logic as described herein. The instructions 424 may reside completely or partially within the memory 404 and/or within the processor 402 during execution by the computer system 400. The memory 404 and the processor 402 also may include computer-readable media as discussed above.

In some systems, computer-readable medium 422 may include the set of instructions 424 or receive and execute the set of instructions 424 responsive to a propagated signal so that a device connected to network 430 can communicate voice, video, audio, images, or any other data over the network 430. Further, the set of instructions 424 may be transmitted or received over the network 430 via communication port or interface 420, and/or using bus 408. The communication port or interface 420 may be a part of the processor 402 or may be a separate component. The communication port or interface 420 may be created in software or may be a physical connection in hardware.

The communication port or interface 420 may be configured to connect with a network 430, external media, the display 410, or any other components in computer system 400, or combinations thereof. The connection with the network 430 may be a physical connection, such as a wired Ethernet connection or may be established wirelessly as discussed below. Likewise, the additional connections with other components of the computer system 400 may be physical connections or may be established wirelessly. The network 430 may alternatively be directly connected to the bus 408.

While the computer-readable medium 422 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 422 may be non-transitory, and may be tangible.

The computer-readable medium 422 may include a solid-state memory such as a memory card or other package that houses one or more non-volatile read-only memories. The computer-readable medium 422 can be a random-access memory or other volatile re-writable memory. Additionally or alternatively, the computer-readable medium 422 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations may broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 400 may be connected to network 430. The network 430 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 430 may include wide area networks (WAN), such as the Internet, local area networks (LAN), campus area networks, metropolitan area networks, a direct connection such as through a Universal Serial Bus (USB) port, or any other networks that may allow for data communication.

The network 430 may be configured to couple one computing device to another computing device to enable communication of data between the devices. The network 430 may generally be enabled to employ any form of machine-readable media for communicating information from one device to another. The network 430 may include communication methods by which information may travel between computing devices.

The network 430 may be divided into sub-networks. The sub-networks may allow access to all of the other components connected thereto or the sub-networks may restrict access between the components. The network 430 may be regarded as a public or private network connection and may include, for example, a virtual private network or an encryption or other security mechanism employed over the public Internet, or the like.

### Exemplary Embodiment

A computer-implemented method for predicting a pure rate for one or more coverage programs may be provided. The computer-implemented method may be performed by one or more local or remote processors of a computing system in communication with one or more local or remote data sources. The computer-implemented method may include (1) collecting, by the one or more processors, rate data associated with the one or more coverage programs during a first time threshold; (2) transforming, by the one or more processors, the rate data by applying a natural logarithm function to the rate data; (3) determining, by the one or more processors, one or more data patterns corresponding to the transformed rate data; (4) utilizing, by the one or more processors, a regression function to calculate an intercept and a slope that correspond to a trend line of the one or more data patterns over a second time threshold; (5) predicting, by the one or more processors, one or more projected rate values for a future point in time using an exponential equation; (6) generating, by the one or more processors, a plot based upon the intercept, the slope, and the one or more projected rate values; (7) analyzing, by the one or more processors, the plot to determine a range of projected rate values for the future point in time; and/or (8) outputting, by the one or more processors, the range of projected rate values for the future point in time based upon the plot.

In some embodiments, the voice bots or chatbots may be configured to utilize AI and/or ML techniques, such as for input or output devices. For instance, a voice bot or chatbot may be a ChatGPT chatbot, an InstructGPT bot, a Codex bot, or a Google Bard bot. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT, InstructGPT bot, Codex bot, or Google Bard bot.

In certain aspects, the computer-implemented method may further include (i) calculating, by the one or more processors, a ratio corresponding to loss data and loss adjustment data divided by a covered unit quantity for each of the one or more coverage programs, wherein the rate data corresponds to the ratio.

In various embodiments, transforming the rate data may include (i) associating, by the one or more processors, each of the transformed rate data with a corresponding time value representing a collection time period, wherein the transformed rate data includes one or more y-values corresponding to one or more changes in the rate data, and wherein the corresponding time value includes one or more x-values corresponding to a time period sequence.

In certain embodiments, predicting the one or more projected rate values for the future point in time using the exponential equation may include (i) applying, by the one or more processors, the intercept and the slope to an exponential model for the future point in time; and/or (ii) generating, by the one or more processors, an exponential line reflecting the one or more patterns for the transformed rate data during an additional time threshold.

In some embodiments, outputting the range of projected rate values may include (i) calculating, by the one or more processors, one or more ratio changes in the rate data between one or more preconfigured time intervals; and/or (ii) determining, by the one or more processors, a rank of the calculated one or more ratio changes by (a) ordering the one or more ratio changes, and (b) identifying a rank for the one or more ratio changes.

Additionally or alternatively, the computer-implemented method may include (i) selecting, by the one or more processors, at least one projected rate value from the one or more projected rate values for the future point in time based upon the rank.

In certain aspects, the computer-implemented method may include (i) applying, by the one or more processors, the selected projected rate value to one or more functions to determine a change in the rate data.

In some embodiments, the computer-implemented method may include (i) inputting, by the one or more processors, the transformed rate data, the range of projected rate values, and historical rate data into a trained machine-learning model, wherein the trained machine-learning model is configured to process the transformed rate data, the range of projected rate values, and the historical rate data to predict one or more future rate values.

Additionally or alternatively, the trained machine-learning model may update one or more weights and one or more parameters based upon the transformed rate data, the range of projected rate values, and the historical rate data.

In some embodiments, the computer-implemented method may include (i) generating, by the one or more processors, via the trained machine-learning model, a confidence score for each of the one or more future rate values, wherein the confidence score is used to adjust one or more ratio changes in the rate data.

In certain aspects, the computer-implemented method may include (i) receiving, by the one or more processors, via the trained machine-learning model, feedback from one or more prior projections; and/or (ii) retraining, by the one or more processors, the trained machine-learning model based upon the received feedback, wherein the retraining includes refining the prediction of the one or more future rate values.

A computer system for predicting a pure rate for one or more coverage programs may be provided. The computer system may include one or more processors of a computing system, and at least one non-transitory computer readable medium storing instructions which, when executed by the one or more processors, cause the one or more processors to perform operations. The computer system may perform operations including (1) collecting rate data associated with the one or more coverage programs during a first time threshold; (2) transforming the rate data by applying a natural logarithm function to the rate data; (3) determining one or more data patterns corresponding to the transformed rate data; (4) utilizing a regression function to calculate an intercept and a slope that correspond to a trend line of the one or more data patterns over a second time threshold; (5) predicting one or more projected rate values for a future point in time using an exponential equation; (6) generating a plot based upon the intercept, the slope, and the one or more projected rate values; (7) analyzing the plot to determine a range of projected rate values for the future point in time; and/or (8) outputting the range of projected rate values for the future point in time based upon the plot.

In certain aspects, the system may further include (i) calculating a ratio corresponding to loss data and loss adjustment data divided by a covered unit quantity for each of the one or more coverage programs, wherein the rate data corresponds to the ratio.

In some embodiments, transforming the rate data may include (i) associating each of the transformed rate data with a corresponding time value representing a collection time period, wherein the transformed rate data includes one or more y-values corresponding to one or more changes in the rate data, and wherein the corresponding time value includes one or more x-values corresponding to a time period sequence.

In certain embodiments, predicting the one or more projected rate values for the future point in time using the exponential equation may include (i) applying the intercept and the slope to an exponential model for the future point in time; and/or (ii) generating an exponential line reflecting the one or more patterns for the transformed rate data during an additional time threshold.

In various embodiments, outputting the range of projected rate values may include (i) calculating one or more ratio changes in the rate data between one or more preconfigured time intervals; and/or (ii) determining a rank of the calculated one or more ratio changes by (a) ordering the one or more ratio changes, and (b) identifying a rank for the one or more ratio changes.

In certain aspects, the system may further include (i) selecting at least one projected rate value from the one or more projected rate values for the future point in time based upon the rank.

In some embodiments, the system may further include (i) applying the selected projected rate value to one or more functions to determine a change in the rate data.

A non-transitory computer readable medium for predicting a pure rate for one or more coverage programs may be provided. The non-transitory computer readable medium may store instructions which, when executed by one or more processors, cause the one or more processors to perform operations. The one or more processors may perform operations including (1) collecting rate data associated with the one or more coverage programs during a first time threshold; (2) transforming the rate data by applying a natural logarithm function to the rate data; (3) determining one or more data patterns corresponding to the transformed rate data; (4) utilizing a regression function to calculate an intercept and a slope that correspond to a trend line of the one or more data patterns over a second time threshold; (5) predicting one or more projected rate values for a future point in time using an exponential equation; (6) generating a plot based upon the intercept, the slope, and the one or more projected rate values; (7) analyzing the plot to determine a range of projected rate values for the future point in time; and/or (8) outputting the range of projected rate values for the future point in time based upon the plot.

In some embodiments, the operations may include (i) calculating a ratio corresponding to loss data and loss adjustment data divided by a covered unit quantity for each of the one or more coverage programs, wherein the rate data corresponds to the ratio.

### ADDITIONAL CONSIDERATIONS

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, and/or functionality of computer-implemented methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

The present embodiments envision collecting and analyzing user or customer data, such as demographic information, transaction history, behavioral patterns, policy details, claim frequencies, loss severity, geographical data, engagement metrics, etc. Such data may be collected and analyzed once the user or customer affirmatively opts into a program, or the customer otherwise affirmatively consents to data being utilized, collected, and/or analyzed.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied upon a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate upon a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for predicting a pure rate for one or more coverage programs, the computer-implemented method performed by one or more processors of a computing system in communication with one or more data sources, the computer-implemented method comprising:
collecting, by the one or more processors, rate data associated with the one or more coverage programs during a first time threshold;
transforming, by the one or more processors, the rate data by applying a natural logarithm function to the rate data;
determining, by the one or more processors, one or more data patterns corresponding to the transformed rate data;
utilizing, by the one or more processors, a regression function to calculate an intercept and a slope that correspond to a trend line of the one or more data patterns over a second time threshold;
predicting, by the one or more processors, one or more projected rate values for a future point in time using an exponential equation;
generating, by the one or more processors, a plot based upon the intercept, the slope, and the one or more projected rate values;
analyzing, by the one or more processors, the plot to determine a range of projected rate values for the future point in time; and
outputting, by the one or more processors, the range of projected rate values for the future point in time based upon the plot.

2. The computer-implemented method of claim 1, the computer-implemented method further comprising:
calculating, by the one or more processors, a ratio corresponding to loss data and loss adjustment data divided by a covered unit quantity for each of the one or more coverage programs, wherein the rate data corresponds to the ratio.

3. The computer-implemented method of claim 1, wherein transforming the rate data further comprises:
associating, by the one or more processors, each of the transformed rate data with a corresponding time value representing a collection time period, wherein the transformed rate data includes one or more y-values corresponding to one or more changes in the rate data, and wherein the corresponding time value includes one or more x-values corresponding to a time period sequence.

4. The computer-implemented method of claim 1, wherein predicting the one or more projected rate values for the future point in time using the exponential equation further comprises:
applying, by the one or more processors, the intercept and the slope to an exponential model for the future point in time; and
generating, by the one or more processors, an exponential line reflecting the one or more patterns for the transformed rate data during an additional time threshold.

5. The computer-implemented method of claim 1, wherein outputting the range of projected rate values further comprises:
calculating, by the one or more processors, one or more ratio changes in the rate data between one or more preconfigured time intervals; and
determining, by the one or more processors, a rank of the calculated one or more ratio changes by (i) ordering the one or more ratio changes, and (ii) identifying a rank for the one or more ratio changes.

6. The computer-implemented method of claim 5, the computer-implemented method further comprising:
selecting, by the one or more processors, at least one projected rate value from the one or more projected rate values for the future point in time based upon the rank.

7. The computer-implemented method of claim 6, the computer-implemented method further comprising:
applying, by the one or more processors, the selected projected rate value to one or more functions to determine a change in the rate data.

8. The computer-implemented method of claim 1, the computer-implemented method further comprising:
inputting, by the one or more processors, the transformed rate data, the range of projected rate values, and historical rate data into a trained machine-learning model, wherein the trained machine-learning model is configured to process the transformed rate data, the range of projected rate values, and the historical rate data to predict one or more future rate values.

9. The computer-implemented method of claim 8, wherein the trained machine-learning model updates one or more weights and one or more parameters based upon the transformed rate data, the range of projected rate values, and the historical rate data.

10. The computer-implemented method of claim 8, the computer-implemented method comprising:
generating, by the one or more processors, via the trained machine-learning model, a confidence score for each of the one or more future rate values, wherein the confidence score is used to adjust one or more ratio changes in the rate data.

11. The computer-implemented method of claim 8, the computer-implemented method further comprising:
receiving, by the one or more processors, via the trained machine-learning model, feedback from one or more prior projections; and
retraining, by the one or more processors, the trained machine-learning model based upon the received feedback, wherein the retraining includes refining the prediction of the one or more future rate values.

12. A computer system for predicting a pure rate for one or more coverage programs, comprising:
one or more processors of a computing system in communication with one or more data sources; and
at least one non-transitory computer readable medium storing instructions which, when executed by the one or more processors, cause the one or more processors to perform operations comprising:
collecting rate data associated with the one or more coverage programs during a first time threshold;
transforming the rate data by applying a natural logarithm function to the rate data;
determining one or more data patterns corresponding to the transformed rate data;
utilizing a regression function to calculate an intercept and a slope that correspond to a trend line of the one or more data patterns over a second time threshold;
predicting one or more projected rate values for a future point in time using an exponential equation;
generating a plot based upon the intercept, the slope, and the one or more projected rate values;
analyzing the plot to determine a range of projected rate values for the future point in time; and
outputting the range of projected rate values for the future point in time based upon the plot.

13. The system of claim 12, further comprising:
calculating a ratio corresponding to loss data and loss adjustment data divided by a covered unit quantity for each of the one or more coverage programs, wherein the rate data corresponds to the ratio.

14. The system of claim 12, wherein transforming the rate data further comprises:
associating each of the transformed rate data with a corresponding time value representing a collection time period, wherein the transformed rate data includes one or more y-values corresponding to one or more changes in the rate data, and wherein the corresponding time value includes one or more x-values corresponding to a time period sequence.

15. The system of claim 12, wherein predicting the one or more projected rate values for the future point in time using the exponential equation further comprises:
applying the intercept and the slope to an exponential model for the future point in time; and
generating an exponential line reflecting the one or more patterns for the transformed rate data during an additional time threshold.

16. The system of claim 12, wherein outputting the range of projected rate values further comprises:
calculating one or more ratio changes in the rate data between one or more preconfigured time intervals; and
determining a rank of the calculated one or more ratio changes by (i) ordering the one or more ratio changes, and (ii) identifying a rank for the one or more ratio changes.

17. The system of claim 16, further comprising:
selecting at least one projected rate value from the one or more projected rate values for the future point in time based upon the rank.

18. The system of claim 17, further comprising:
applying the selected projected rate value to one or more functions to determine a change in the rate data.

19. A non-transitory computer readable medium for predicting a pure rate for one or more coverage programs, the non-transitory computer readable medium storing instructions which, when executed by one or more processors of a computing system in communication with one or more data sources, cause the one or more processors to perform operations comprising:
collecting rate data associated with the one or more coverage programs during a first time threshold;
transforming the rate data by applying a natural logarithm function to the rate data;
determining one or more data patterns corresponding to the transformed rate data;
utilizing a regression function to calculate an intercept and a slope that correspond to a trend line of the one or more data patterns over a second time threshold;
predicting one or more projected rate values for a future point in time using an exponential equation;
generating a plot based upon the intercept, the slope, and the one or more projected rate values;
analyzing the plot to determine a range of projected rate values for the future point in time; and
outputting the range of projected rate values for the future point in time based upon the plot.

20. The non-transitory computer readable medium of claim 19, further comprising:
calculating a ratio corresponding to loss data and loss adjustment data divided by a covered unit quantity for each of the one or more coverage programs, wherein the rate data corresponds to the ratio.
